(19) United States
(12) Patent Application Publication
(10) Pub. No.: US 2025/0095356 A1
(43) Pub. Date: Mar. 20, 2025

(54) INFORMATION PROCESSING APPARATUS, INFORMATION PROCESSING SYSTEM, COMPUTER-READABLE RECORDING MEDIUM, AND INFORMATION PROCESSING METHOD

(71) Applicant: SONY SEMICONDUCTOR SOLUTIONS CORPORATION, KANAGAWA (JP)

(72) Inventor: HIROTAKA ISHIKAWA, KANAGAWA (JP)

(21) Appl. No.: 18/727,761

(22) PCT Filed: Dec. 2, 2022
(86) PCT No.: PCT/JP2022/044521

§ 371 Date: Jul. 10, 2024

(30) Foreign Application Priority Data
Jan. 19, 2022 (JP) 2022-006315

(51) Int. Cl. G06V 10/94; G06V 10/77; G06V 10/82; G06V 20/52

(52) U.S. Cl. CPC G06V 10/955; G06V 10/7715; G06V 10/82; G06V 20/52

(57) ABSTRACT

An information processing apparatus (1) includes: a processing section (112, 122) that processes data using a first neural network (NN1) which constitutes a part of an overall neural network (NN) and includes, in an output portion, a bottleneck portion (BN12) where the amount of transmission data is minimum or extremely small in the overall neural network (NN); and a transmission section (124) that transmits data of the bottleneck portion (BN12) of the first neural network (NN1), obtained by the processing using the first neural network (NN1) performed by the processing section (112, 122), to the outside.

### FIELD

The present disclosure relates to an information processing apparatus, an information processing system, a computer-readable recording medium, and an information processing method.

### BACKGROUND

Processing of data using a neural network has been known (see, for example, Patent Literature 1).

### CITATION LIST

### Patent Literature

Patent Literature 1: JP 2020-173782 A

### SUMMARY

### Technical Problem

It is conceivable to arrange the neural network in a plurality of devices in a dispersed fashion. In this case, data transmission between the neural networks (devices) is needed. When the amount of transmission data is large, a load may be applied to a transmission path, and the speed of data processing may be reduced due to a data transmission speed limit of the transmission path or the like.

One aspect of the present disclosure suppresses the amount of transmission data.

### Solution to Problem

An information processing apparatus according to one aspect of the present disclosure includes: a processing section that processes data using a first neural network which constitutes a part of an overall neural network and includes, in an output portion, a bottleneck portion where the amount of transmission data is minimum or extremely small in the overall neural network; and a transmission section that transmits data of the bottleneck portion of the first neural network, obtained by the processing using the first neural network performed by the processing section, to the outside.

An information processing system according to one aspect of the present disclosure includes: a first information processing apparatus that is the information processing apparatus as mentioned above; and a second information processing apparatus that processes data of the bottleneck portion of the first neural network of the first information processing apparatus using a second neural network constituting the remainder of the overall neural network.

An information processing apparatus according to one aspect of the present disclosure includes: a receiving section that receives, from the outside, data of a bottleneck portion of a first neural network which constitutes a part of an overall neural network and includes the bottleneck portion in an output portion, the bottleneck portion being a portion where the amount of transmission data is minimum or extremely small in the overall neural network; and a processing section that processes the data of the bottleneck portion of the first neural network received by the receiving section using a second neural network constituting the remainder of the overall neural network.

A computer-readable recording medium according to one aspect of the present disclosure records a program for causing a computer to function as: a processing section that processes data using a first neural network which constitutes a part of an overall neural network and includes, in an output portion, a bottleneck portion where the amount of transmission data is minimum or extremely small in the overall neural network; and a transmission section that transmits data of the bottleneck portion of the first neural network, obtained by the processing performed by the processing section, to the outside.

An information processing method according to one aspect of the present disclosure includes: by a second information processing apparatus, preparing, according to a capability of a first information processing apparatus, a first neural network that constitutes a part of an overall neural network and includes, in an output portion, a bottleneck portion where the amount of transmission data is minimum or extremely small in the overall neural network; and by the second information processing apparatus, transmitting the prepared first neural network to the first information processing apparatus.

### BRIEF DESCRIPTION OF DRAWINGS

FIG. 1 is a diagram depicting an example of a schematic configuration of an information processing system according to an embodiment.

FIG. 2 is a diagram depicting an example of functional blocks of the information processing system.

FIG. 3 is a diagram schematically depicting an example of a schematic configuration of an overall neural network.

FIG. 4 is a diagram depicting an example of a bottleneck portion.

FIG. 5 is a diagram depicting an example of functional blocks of the information processing system.

FIG. 6 is a diagram depicting an example of a feature map.

FIG. 7 is a diagram depicting an example of a method of designing a neural network.

FIG. 8 is a diagram depicting an example of network search processing according to the DARTS technology.

FIG. 9 is a diagram depicting an example of a schematic configuration of the information processing system.

FIG. 10 is a flowchart depicting an example of processing (information processing method) executed in the information processing system.

FIG. 11 is a flowchart depicting an example of processing (information processing method) executed in the information processing system.

FIG. 12 is a block diagram depicting an example of a hardware configuration.

FIG. 13 is a block diagram depicting an example of schematic configuration of a vehicle control system.

FIG. 14 is a diagram of assistance in explaining an example of installation positions of an outside-vehicle information detecting section and an imaging section.

### DESCRIPTION OF EMBODIMENTS

Hereinafter, embodiments of the present disclosure will be described in detail with reference to the drawings. Incidentally, in the following embodiments, the same elements are denoted by the same reference signs to omit redundant description.

The present disclosure will be described according to the following order of items.
1. Embodiment
1.1. Data Compression
1.2. Neural Network Design Method

1.3. Preparation of First Neural Network According to Capability of Information Processing Apparatus
1.4. Dynamic Change in Range of First Neural Network
2. Hardware Configuration Example
3. Effect Example
4. Application Example

### 1. Embodiment

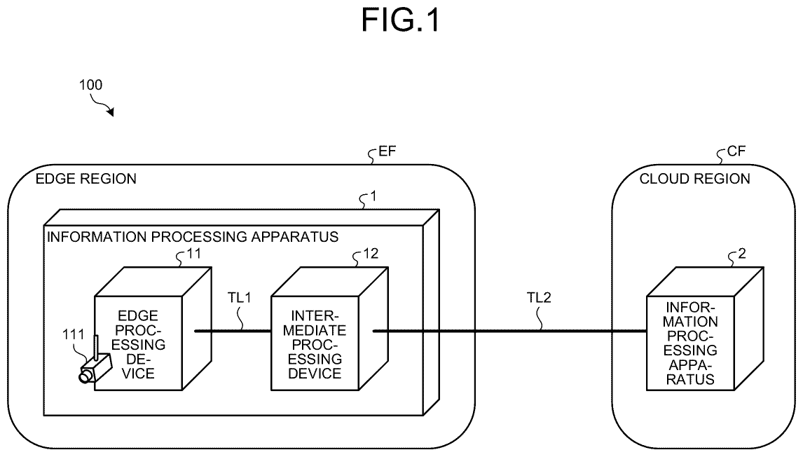

FIG. 1 is a diagram depicting an example of a schematic configuration of an information processing system according to an embodiment. An information processing system 100 includes an information processing apparatus 1 and an information processing apparatus 2. The information processing apparatus 1 is a first information processing apparatus constituting the information processing system 100. The information processing apparatus 2 is a second information processing apparatus constituting the information processing system 100.

The information processing apparatus 1 is arranged in an edge region EF. The edge region EF is a region including a place where data to be processed by the information processing system 100 is acquired or a region near this place. Examples of the edge region EF are regions in a retail store, a vehicle, an office, a factory, and the like.

In the example depicted in FIG. 1, the information processing apparatus 1 includes an edge processing device 11 and an intermediate processing device 12. FIG. 1 also depicts an acquisition section 111 among components of the edge processing device 11. In this example, the acquisition section 111 is a camera (for example, a surveillance camera in a store), and data acquired by the acquisition section 111 is image data. The data acquired by the acquisition section 111 may be time-series data, and in this case, the image data may be a plurality of pieces of image data (video data) each corresponding to one frame.

In the edge region EF, the edge processing device 11 is arranged at a position closer to an imaging target than the intermediate processing device 12, for example, near a place where a product is displayed in a store. The intermediate processing device 12 is disposed at a position farther from the imaging target than the edge processing device 11, for example, in a backyard such as an employee room or a warehouse in the store.

The edge processing device 11 and the intermediate processing device 12 are connected by a private network. The private network is constructed using, for example, a local network in the store. The private network provides a transmission path TL1 that is a private transmission path. Data is transmitted from the edge processing device 11 to the intermediate processing device 12 via the transmission path TL1. Bidirectional communication between the edge processing device 11 and the intermediate processing device 12 by the private network is also possible.

The information processing apparatus 2 is arranged in a cloud region CF. The cloud region CF is a region away from the edge region EF. The information processing apparatus 1 (in this example, the intermediate processing device 12 of the information processing apparatus 1) and the information processing apparatus 2 are connected via a public network. The public network is constructed using the Internet or the like. The public network provides a transmission path TL2 that is a public transmission path. Data is transmitted from the information processing apparatus 1 to the information processing apparatus 2 via the transmission path TL2. Bidirectional communication between the information processing apparatus 1 and the information processing apparatus 2 by the public network is also possible.

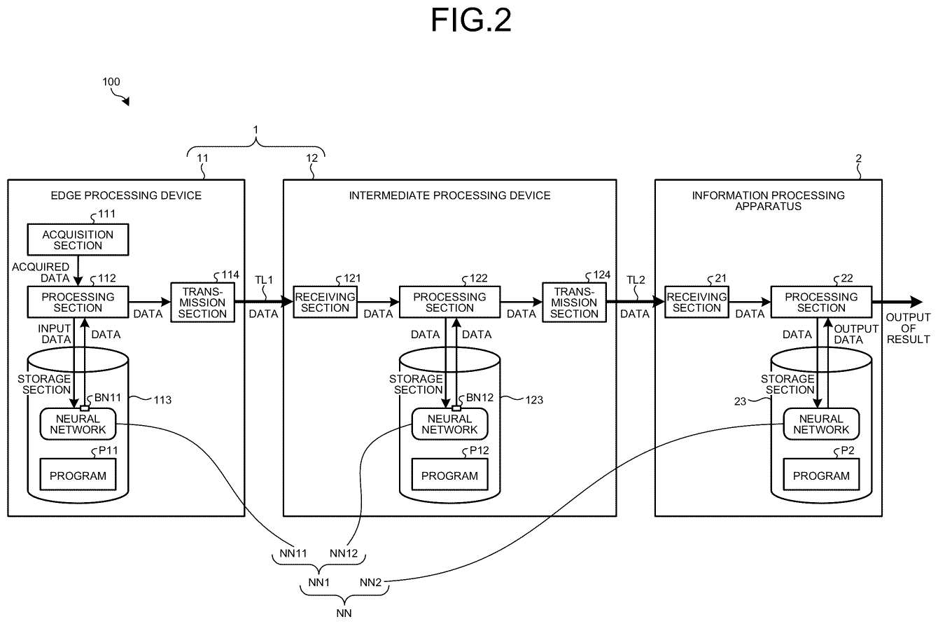

FIG. 2 is a diagram depicting an example of functional blocks of the information processing system. In the information processing system 100, the data acquired by the acquisition section 111 of the information processing apparatus 1 is processed using neural networks arranged in the information processing apparatus 1 and the information processing apparatus 2 in a dispersed fashion. The processing using the neural networks is also referred to as inference processing, for example. A neural network including all the neural networks arranged in a dispersed fashion is referred to as an overall neural network NN. Examples of the overall neural network NN include a Convolutional Neural Network (CNN), a Recurrent Neural Network (RNN), and the like. Unless otherwise specified, it is assumed below that the overall neural network NN is a CNN.

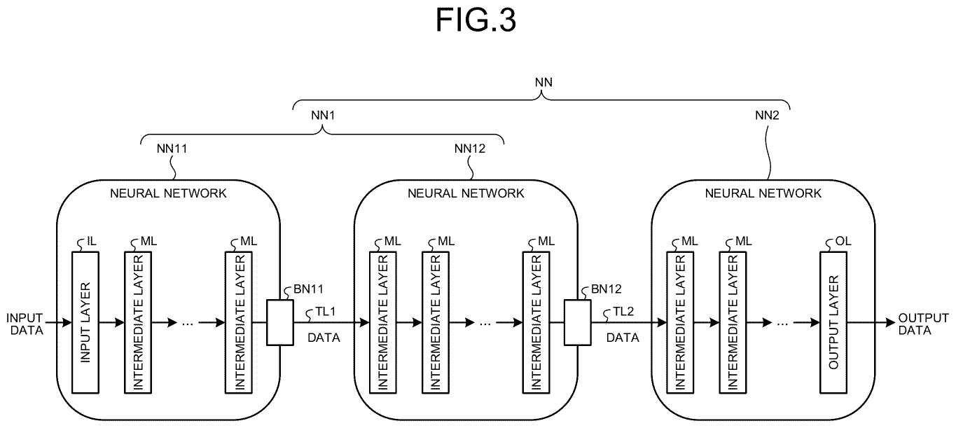

FIG. 3 is a diagram schematically depicting an example of a schematic configuration of the overall neural network. The overall neural network NN includes an input layer IL, a plurality of intermediate layers ML, and an output layer OL. An example of the intermediate layer ML is a convolution layer or the like. Data of the intermediate layer ML is data of an intermediate product generated during processing in the overall neural network NN, and is also referred to as intermediate layer data or the like. The data of the intermediate layer ML includes, for example, a feature map.

The overall neural network NN is a learned model generated by machine learning using training data so that the output layer OL outputs output data when input data is input to the input layer IL. The input data of the overall neural network NN is data acquired by the acquisition section 111 of the information processing apparatus 1 described above or data corresponding to this data (data subjected to modification or the like to be suitable for input to the overall neural network NN), and is, for example, image data. The output data is data indicating a processing result by the overall neural network NN, and is data such as an image recognition result. For example, by using the processing result of the image data of the store as described above, it is possible to analyze the behavior of customers and consider measures for increasing the sales, or detect a suspicious person and prevent a crime in advance.

The overall neural network NN is used by being divided into two or more neural networks. Specifically, the overall neural network NN includes a neural network NN1 that is a first neural network and a neural network NN2 that is a second neural network. Although not necessary, the neural network NN1 may be further divided, and in this example, the neural network NN1 is divided into a neural network NN11 and a neural network NN12.

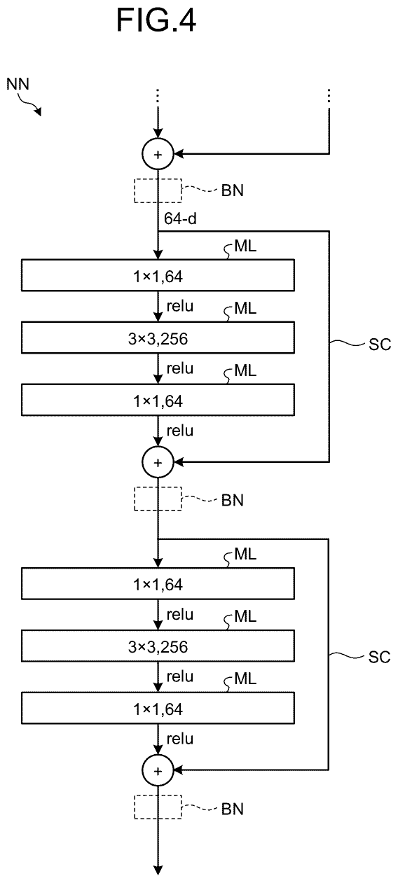

The overall neural network NN can be created to include one or more bottleneck portions BN. FIG. 3 depicts two bottleneck portions BN, i.e., a bottleneck portion BN11 and a bottleneck portion BN12. The bottleneck portion BN will be described with reference to FIG. 4.

FIG. 4 is a diagram depicting an example of the bottleneck portion. A part of the overall neural network NN is schematically depicted. “64-d” indicates data (64-dimensional data) having 64 channels. The “1×1, 64” in the intermediate layer ML depicted at the top indicates that the size of the filter is 1×1 and the number of channels is 64. The same applies to the notation in the other intermediate layers ML. “relu” is a Rectified Linear Unit (ReLU) layer and is an example of an activation function layer. Shortcut connections SC that bypass some intermediate layers ML are also depicted. Data bypassed by the shortcut connection SC is incorporated into data from the intermediate layer ML of the last stage among the intermediate layers ML to be bypassed. Incidentally, the shortcut connection SC is also referred to as a skip connection or the like.

In the example depicted in FIG. 4, there are three bottleneck portions BN. The bottleneck portion BN is a portion where the amount of transmission data is minimum or extremely small in the overall neural network NN. More specifically, the bottleneck portion BN is a portion where the amount of transmission data in the overall neural network NN in a portion not bypassed by the shortcut connection SC is minimum or extremely small. In other words, all the data at that stage passes through the bottleneck portion BN. As will be described later, when data of the bottleneck portion BN is transmitted, data necessary for processing in the overall neural network NN is transmitted without omission.

The bottleneck portion BN may be a portion where the number of channels in the overall neural network NN (in a portion not bypassed by the shortcut connection SC) is minimum or extremely small. For example, the number of channels of the bottleneck portion BN is smaller than the number of channels of front and rear portions (such as the intermediate layer ML). At the same time, or alternatively, the bottleneck portion BN may be a portion where the number of channels in the overall neural network NN (in a portion not bypassed by the shortcut connection SC) is minimum or extremely small.

Returning to FIG. 3, as described above, the bottleneck portion BN11 and the bottleneck portion BN12 are exemplified as the bottleneck portions BN included in the neural network NN1. The neural network NN1 constitutes a part of the overall neural network NN and includes the bottleneck portion BN12 in an output portion. The bottleneck portion BN12 is a portion located behind the intermediate layer ML of the last stage among the intermediate layers ML of the neural network NN1.

As described above, in this example, the neural network NN1 includes the neural network NN11 and the neural network NN12. The neural network NN11 constitutes a part of the neural network NN1 and includes the bottleneck portion BN11 in an output portion. The bottleneck portion BN11 is a portion located behind the intermediate layer ML of the last stage among the intermediate layers ML of the neural network NN11. The neural network NN12 constitutes the remaining part of the neural network NN1 and includes the bottleneck portion BN12 in an output portion. The bottleneck portion BN12 is a portion located behind the intermediate layer ML of the last stage among the intermediate layers ML of the neural network NN12.

Data of the bottleneck portion BN11 of the neural network NN11 is transmitted to the neural network NN12 via the transmission path TL1. Data of the bottleneck portion BN12 of the neural network NN1 (the neural network NN12 in this example) is transmitted to the neural network NN2 via the transmission path TL2.

Returning to FIG. 2, the neural network NN1 and the neural network NN2 described above are arranged in the information processing apparatus 1 and the information processing apparatus 2 in a dispersed fashion. More specifically, in this example, the neural network NN11 and the neural network NN12 of the neural network NN1 are arranged in the edge processing device 11 and the intermediate processing device 12 of the information processing apparatus 1. Functional blocks of each device will be described in order.

The edge processing device 11 includes a processing section 112, a storage section 113, and a transmission section 114 in addition to the acquisition section 111 described above. In addition to the neural network NN11 described above, a program P11 is also exemplified as information stored in the storage section 113. The program P11 is a program (software or the like) for causing a computer to function as the edge processing device 11.

As described above, the acquisition section 111 acquires, for example, data such as image data. The data acquired by the acquisition section 111 is referred to as “acquired data” in the drawing. Unless otherwise specified, the acquired data is assumed to be image data.

The processing section 112 processes the acquired data using the neural network NN11 stored in the storage section 113. The processing section 112 inputs acquired data or input data corresponding to the acquired data into the neural network NN11. The neural network NN11 outputs data of the bottleneck portion BN11. Data of the bottleneck portion BN11 of the neural network NN11 is obtained by the above processing using the neural network NN11 performed by the processing section 112.

The transmission section 114 transmits the data obtained by the above processing by the processing section 112, that is, the data of the bottleneck portion BN11 of the neural network NN11 to the outside of the edge processing device 11, in this example, the intermediate processing device 12. The data is transmitted via the transmission path TL1.

The intermediate processing device 12 includes a receiving section 121, a processing section 122, a storage section 123, and a transmission section 124. In addition to the neural network NN12 described above, a program P12 is also exemplified as information stored in the storage section 123. The program P12 is a program (software or the like) for causing a computer to function as the intermediate processing device 12.

The receiving section 121 receives data transmitted by the transmission section 114 of the edge processing device 11, that is, data of the bottleneck portion BN11 of the neural network NN11.

The processing section 122 processes the data, received by the receiving section 121, using the neural network NN12 stored in the storage section 123. The processing section 122 inputs the data, received by the receiving section 121, into the neural network NN12. The neural network NN12 outputs data of the bottleneck portion BN12. Data of the bottleneck portion BN12 of the neural network NN12 is obtained by the above processing using the neural network NN12 performed by the processing section 122.

The transmission section 124 transmits the data obtained by the above processing by the processing section 122, that is, the data of the bottleneck portion BN12 of the neural network NN12 to the outside of the intermediate processing device 12 (the outside of the information processing apparatus 1), in this example, the information processing apparatus 2. The data is transmitted via the transmission path TL2.

Incidentally, in this embodiment, a case where the information processing apparatus 1 includes two devices of the edge processing device 11 and the intermediate processing device 12 will be described as an example, but the information processing apparatus 1 may be a single apparatus. The operations and the like of the edge processing device 11 and the intermediate processing device 12 in that case may be appropriately read as the operation of the information processing apparatus 1. For example, the processing using the neural network NN11 by the processing section 112 of the edge processing device 11 and the processing using the neural network NN12 by the processing section 122 of the intermediate processing device 12 may be appropriately read as processing using the neural network NN1 by the information processing apparatus 1. The transmission of the data of the bottleneck portion BN12 of the neural network NN12 by the transmission section 124 of the intermediate processing device 12 may be appropriately read as transmission of the data of the bottleneck portion BN12 of the neural network NN1 by the information processing apparatus 1. In other words, the information processing apparatus 1 processes the acquired data using the neural network NN1, and transmits the data of the bottleneck portion BN12 of the neural network NN11 obtained by this processing to the information processing apparatus 2 outside the information processing apparatus 1.

The information processing apparatus 2 includes a receiving section 21, a processing section 22, and a storage section 23. In addition to the neural network NN2 described above, a program P2 is also exemplified as information stored in the storage section 23. The program P2 is a program (software or the like) for causing a computer to function as the information processing apparatus 2.

The receiving section 21 receives the data transmitted by the transmission section 124 of the intermediate processing device 12, that is, the data of the bottleneck portion BN12 of the neural network NN12 (of the neural network NN1).

The processing section 22 processes the data, received by the receiving section 21, using the neural network NN2 stored in the storage section 23. The processing section 22 inputs the data, received by the receiving section 21, into the neural network NN2. The neural network NN2 outputs output data. By the above processing using the neural network NN2 by the processing section 22, a processing result (such as an inference result) of the data acquired by the acquisition section 111 of the information processing apparatus 1 is obtained. The information processing apparatus 2 outputs the processing result thus obtained. The processing result may be transmitted to and fed back to the information processing apparatus 1.

As described above, in the information processing system 100, data is processed using the overall neural network NN. By utilizing a plurality of devices, that is, the information processing apparatus 1 and the information processing apparatus 2, more specifically, the edge processing device 11, the intermediate processing device 12, and the information processing apparatus 2, for example, high-performance processing can be performed as compared with a case of using only the information processing apparatus 1.

In addition, in the information processing system 100, data of the bottleneck portion BN12 of the neural network NN1 of the information processing apparatus 1 is transmitted to the information processing apparatus 2. Since the amount of data of the bottleneck portion BN12 is smaller than the amount of data of the other portions, the amount of transmission data can be suppressed as compared with the case where the data of the portions other than the bottleneck portion BN is transmitted as it is. This makes it possible to reduce a load on the transmission path TL2 and to suppress a decrease in the data processing speed that may otherwise occur due to the data transmission speed limitation or the like of the transmission path TL2. For example, in the case of image data processing, a decrease in the processing frame rate can be prevented. The same applies to the transmission path TL1.

Since the amount of transmission data is suppressed, distribution of the processing using the overall neural network NN is possible even when the transmission capacity or the like of the transmission path TL1 or the transmission path TL2 is not so large. Since the configuration of the information processing system 100 is reduced in weight, it also leads to a reduction in hardware cost.

The transmission data is, for example, a feature map and is not original image data. Therefore, problems such as privacy caused by data transmission hardly occur. In addition, the later stage the feature map is located in the overall neural network NN, the information of the initial image data is lost. In particular, there is an advantage that data transmission is easy even in the transmission path TL2 which is a public transmission path. Incidentally, as a matter of course, encrypted communication is often used in the public transmission path, and problems such as privacy are mainly solved by the encrypted communication.

### 1.1. Data Compression

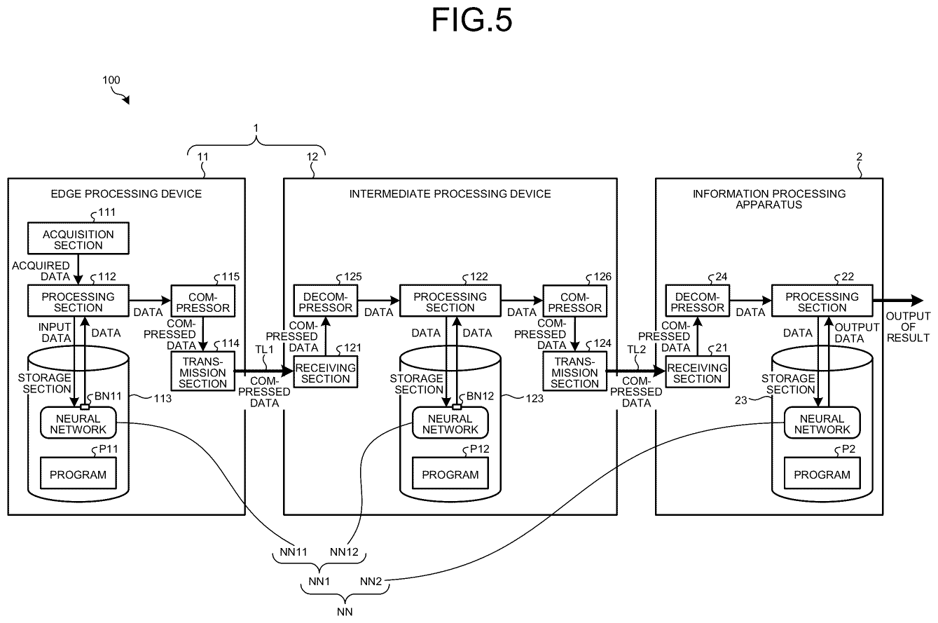

In one embodiment, compressed data may be transmitted. This makes it possible to further suppress the amount of transmission data. This will be described with reference to FIG. 5.

FIG. 5 is a diagram depicting an example of functional blocks of the information processing system. The edge processing device 11 further includes a compressor 115. The compressor 115 compresses data obtained by the processing by the processing section 112, that is, data of the bottleneck portion BN11 of the neural network NN11. Although a specific example will be described later, the data compression may be lossless data compression from the viewpoint of maintaining the data content and processing performance, or may be lossy data compression from the viewpoint of further increasing the compression rate. The data thus compressed is referred to as “compressed data” in the drawing. The transmission section 114 transmits the compressed data to the intermediate processing device 12 via the transmission path TL1.

The receiving section 121 of the intermediate processing device 12 receives the compressed data transmitted by the transmission section 114. The intermediate processing device 12 further includes a decompressor 125 and a compressor 126. The decompressor 125 decompresses the compressed data received by the receiving section 121. In a case where the data compression is lossless data compression, the same data as the data before compression is obtained. In a case where the data compression is lossy data compression, substantially the same data as the data before compression is obtained. Unless otherwise specified, substantially the same data is simply referred to as the same data. The processing section 122 uses the neural network NN12 to process the data before compression obtained by decompression by the decompressor 125. The compressor 126 compresses data obtained by the processing by the processing section 122, that is, data of the bottleneck portion BN12 of the neural network NN12. The transmission section 124 transmits the compressed data, obtained by the compression by the compressor 126, to the information processing apparatus 2 via the transmission path TL2.

The receiving section 21 of the information processing apparatus 2 receives the compressed data from the intermediate processing device 12. The information processing apparatus 2 further includes a decompressor 24. The decompressor 24 decompresses the compressed data received by the receiving section 21. The same data as the data before compression is obtained. The processing section 22 uses the neural network NN2 to process the data before compression obtained by the decompression by the decompressor 24, that is, data of the bottleneck portion BN12 of the neural network NN12 (of the neural network NN1).

For example, by transmitting the compressed data as described above, the amount of transmission data can be further suppressed as compared with the case of transmitting uncompressed data. This makes it possible to reduce a load on the transmission path TL1 and the transmission path TL2 and to further enhance the effect of suppressing the decrease in the data processing speed that may otherwise occur due to the data transmission speed limitation or the like of these transmission paths.

Some examples of data compression formats will be described. For example, the data compression may include data compression in a time direction (time-direction compression). An example of the time-direction compression is motion compensation. By appropriately mixing an I picture, a P picture, and a B picture in time series, a data compression effect can be obtained. The I picture is a completely independent frame that does not refer to other frames. The P picture is a frame in which only a difference generated by transformation from a previous frame is recorded as data. The B picture is a frame in which only a difference changed from the immediately following frame is recorded as data.

The data compression may include data compression in a spatial direction (spatial-direction compression). An example of the spatial-direction compression is transformation into a frequency domain. An example of the change to the frequency domain is Discrete Cosine Transform (DCT) or the like that transforms a discrete signal into the frequency domain, and a data compression effect can be obtained by the transformation. Incidentally, since some feature maps are important for high frequency components, in that case, parameters of data compression and the like may be appropriately designed so that the high frequency components are less likely to be lost. Further, quantization may be performed. In quantization, a data compression effect can be obtained by reducing the number of bits (for example, a fraction is rounded down).

The data compression may include data compression in an information direction (information-direction compression). An example of the information-direction compression is entropy coding or the like. An example of the entropy coding is Huffman coding. In Huffman coding, information having a high appearance frequency is represented by a short bit string, and information having a low appearance frequency is represented by a bit string, thereby reducing the amount of data required for coding the entire information. The entropy coding makes it possible to efficiently compress particularly feature maps.

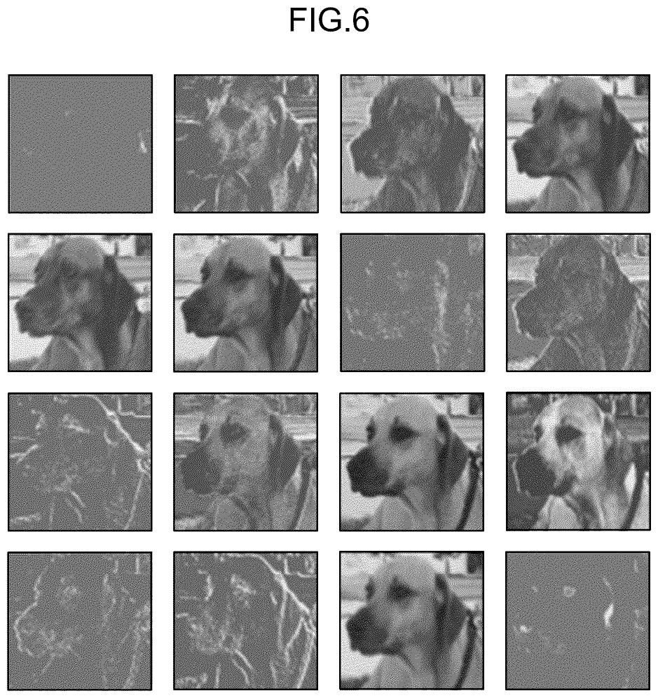

FIG. 6 is a diagram depicting an example of a feature map. 16 types of feature maps are depicted, which are intermediate products generated in the process of processing of dog image data. The feature map does not necessary have to include color information. This limits the range of the amount of information included in the feature map, thus reducing the entropy. Thus, a large data compression effect by entropy coding can be obtained.

Various data compression formats as described above may be appropriately combined and used. As an example of data compression formats in which a data compression effect is likely to be obtained, data compression by motion compensation, data compression by DCT and data compression by quantization, and data compression by Huffman coding may be sequentially applied to the feature map.

Parameters of data compression by the data compression format are set on the basis of, for example, a simulation result or the like. The simulation is a simulation of processing using the overall neural network NN including compression and decompression of data. Based on the simulation result, a combination of parameters having a good compression rate while maintaining the performance of the overall neural network NN as much as possible may be set.

Incidentally, transmission of data and compression and decompression of data may increase the processing latency to some extent. On the other hand, since the processing in each device can be executed in a pipeline manner, as a result, a decrease in the processing frame rate is suppressed.

Incidentally, in a case where the acquisition section 111 is a monitoring camera in a store, even if inference processing by the overall neural network NN is slightly delayed, this hardly causes a problem.

### 1.2. Neural Network Design Method

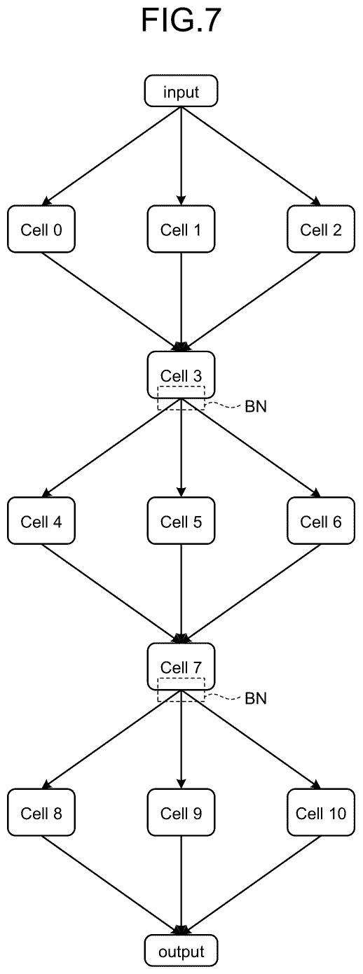

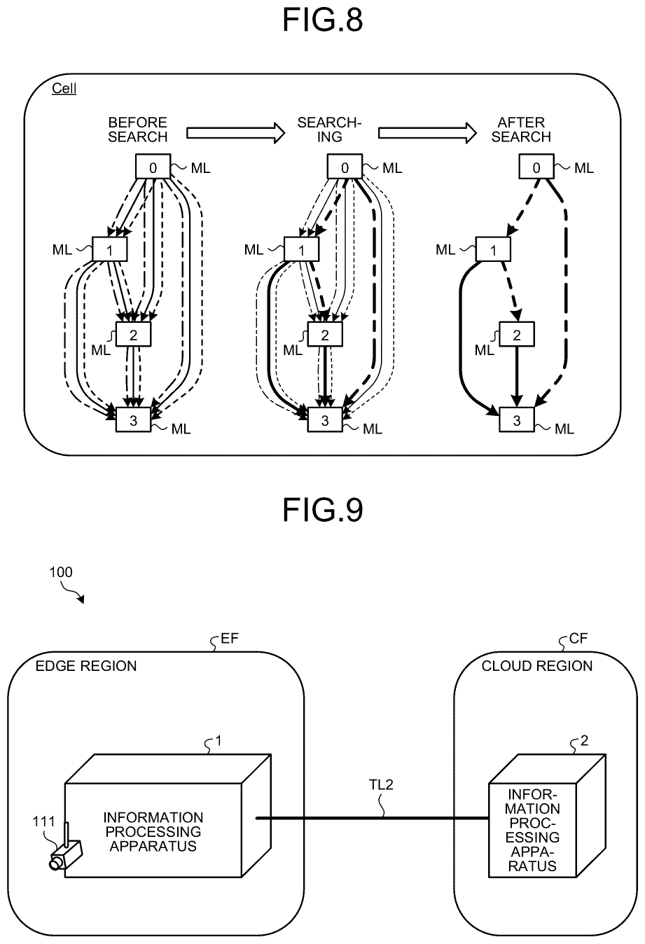

Various known technologies may be used to design the overall neural network NN. For example, the Neural Architecture Search (NAS) technology, more specifically, the Differentiable Architecture Search (DARTS) technology, the once-for-all technology, or the like may be used. An example will be described with reference to FIGS. 7 and 8.

FIG. 7 is a diagram depicting an example of a method of designing a neural network. In this example, a neural network is designed using the DARTS technology. “input” is a portion to which input data is input. “output” is a portion to which output data is output. A plurality of Cells are arranged between input and output. The arrangement of the Cells is manually designed by a user operation or the like. In this example, 11 Cells of Cell 1 to Cell 10 are arranged.

The arrangement design of the Cells makes it possible to create the bottleneck portions BN at a connection portion (joint) between the Cells. The bottleneck portions BN may be formed in consideration of the processing capacity of each of the information processing apparatus 1 and the information processing apparatus 2, more specifically, the processing capacity of each of the edge processing device 11, the intermediate processing device 12, and the information processing apparatus 2.

In this example depicted in FIG. 7, the bottleneck portion BN is created in each of an output portion of the Cell 3 and an output portion of the Cell 7. Specifically, by arranging the Cell 3 so that data of the Cell 0 to the Cell 2 are aggregated in the Cell 3, the bottleneck portion BN can be created in the output portion of the Cell 3. By arranging the Cell 7 so that data of the Cell 4 to the Cell 6 are aggregated in the Cell 7, the bottleneck portion BN can be created in the output portion of the Cell 7.

For example, the bottleneck portion BN of the output portion of the Cell 3 corresponds to the bottleneck portion BN11 of the neural network NN11. The bottleneck portion BN of the output portion of the Cell 7 corresponds to the bottleneck portion BN12 of the neural network NN12. After the Cells are arranged so that the bottleneck portions BN are formed, a final neural network is generated by network search processing according to the DARTS technology.

FIG. 8 is a diagram depicting an example of the network search processing according to the DARTS technology. A configuration of one Cell is schematically depicted. The Cell includes a plurality of intermediate layers ML. As indicated by “before search” in the drawing, an initial connection relationship between the intermediate layers ML is given. As indicated by “searching”, an optimal connection relationship between the intermediate layers ML is searched. As indicated by “after search”, the Cell including the plurality of intermediate layers ML connected in the optimized connection relationship is obtained. The neural network thus designed is obtained as the overall neural network NN.

### 1.3. Preparation of First Neural Network According to Capability of Information Processing Apparatus

In one embodiment, the information processing apparatus 2 may prepare the overall neural network NN including the neural network NN1 and the neural network NN2. This will be described with reference to FIG. 9.

FIG. 9 is a diagram depicting an example of a schematic configuration of the information processing system. For facilitating understanding, the information processing apparatus 1 will be described as one apparatus. In other words, the information processing apparatus 1 uses the neural network NN1 to process data acquired by the acquisition section 111. The information processing apparatus 1 transmits data of the bottleneck portion BN12 of the neural network NN1 to the information processing apparatus 2 via the transmission path TL2. The information processing apparatus 2 processes the received data using the neural network NN2.

The information processing apparatus 2 prepares the overall neural network NN according to the capability of the information processing apparatus 1. As a related technology, a Network of Intelligent Camera Ecosystem (NICE) protocol is known. By improving the NICE protocol, the neural network NN1 and the neural network NN2 can be distributed and arranged in the information processing apparatus 1 and the information processing apparatus 2 to realize the information processing system 100 as described above.

It is possible to provide various applications using the NICE protocol. For example, using an in-vehicle camera as the acquisition section 111 of the information processing apparatus 1, data of the bottleneck portion BN12 of the neural network NN1 that processes this image data may be wirelessly transmitted to the information processing apparatus 2 for processing. The driving situation can be analyzed based on the image data, and the analysis result can be fed back to a driver.

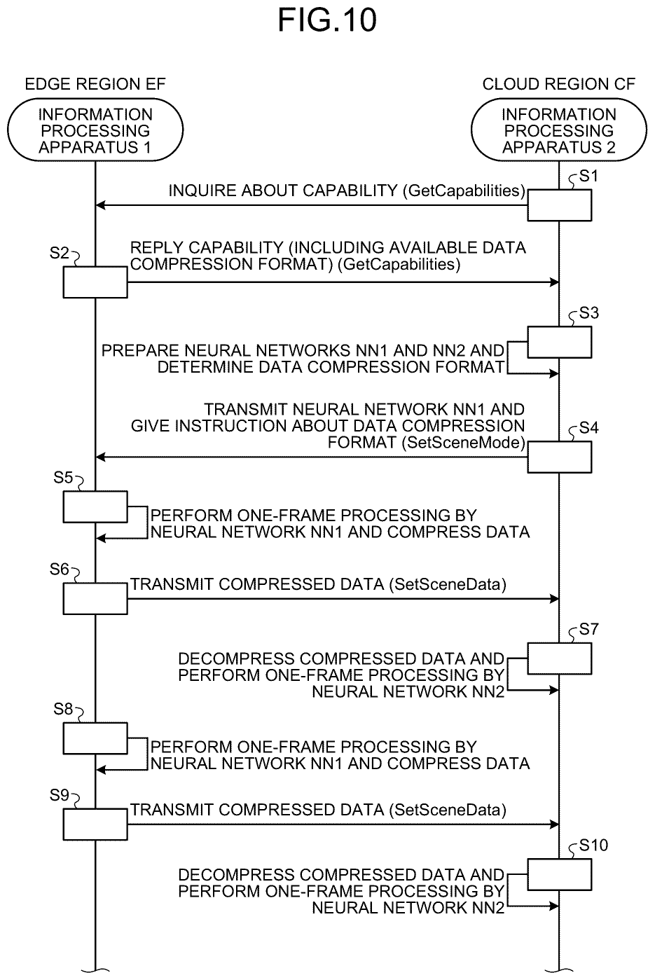

FIG. 10 is a flowchart depicting an example of processing (information processing method) executed in the information processing system. Description of contents overlapping with the above description will be omitted as appropriate.

In Step S1, the information processing apparatus 2 inquires of the information processing apparatus 1 about the capability of the information processing apparatus 1. The capability mentioned here corresponds to Capabilities in the NICE protocol. Examples of the capability include, for example, whether or not imaging (or shooting) is possible, whether or not data formats such as JPEG and H.264 are possible, and available SceneMode (to be described later). The capability can also be said to be information on the scale or processing capacity of the information processing apparatus 1.

In Step S2, the information processing apparatus 1 replies the capability of the information processing apparatus 1 to the information processing apparatus 2. Here, the capability of the information processing apparatus 1 to reply to the information processing apparatus 2 further includes a data compression format that can be used by the information processing apparatus 1.

The processing in Steps S1 and S2 described above may be incorporated in GetCapabilities processing of the NICE protocol.

In Step S3, the information processing apparatus 2 prepares the neural network NN1 and the neural network NN2, and determines the data compression format. For example, in the information processing apparatus 2, table data describing the capability and application of the apparatus and the neural network in association with each other may be stored in the storage section 23. The processing section 22 selects an appropriate neural network according to the capability of the information processing apparatus 1 and the application by referring to the table data. This neural network can correspond to the overall neural network NN. According to the capability of the information processing apparatus 1, the information processing apparatus 2 prepares the neural network NN1 that constitutes a part of the overall neural network NN and includes the bottleneck portion BN12 in an output portion. Further, the information processing apparatus 2 prepares the neural network NN2 constituting the remainder of the overall neural network NN. The data compression format may be appropriately determined within the range of the data compression format indicated in the capability replied from the information processing apparatus 1.

Incidentally, the neural network NN may be generated and prepared each time using the NAS technology described above instead of selecting from the neural network prepared in advance with reference to the table data as described above. In addition, the neural network prepared in advance may be used as the overall neural network NN at the beginning, and then replaced with the neural network NN generated using the NAS technology.

In Step S4, the information processing apparatus 2 transmits the prepared neural network NN1 to the information processing apparatus 1 and instructs the information processing apparatus 1 to use the determined data compression format. Parameters and the like necessary for the neural network NN1 and data compression are also transmitted to the information processing apparatus 1. The process of Step S4 may be incorporated into the process of SetSceneMode of the NICE protocol.

SetSceneMode is an API for setting SceneMode, and is used to set a mode such as person detection or moving object detection, for example. Examples of SceneMode include “Face”, “Human”, “Object”, “Label”, “Animal”, “Text/Logo/QRCode”, “Vehicle”, and “Custom”. For example, a mode for detecting a person's face (detection of a person's face serves as a trigger) is set by designating “Face”. By designating “Animal”, a mode for detecting an animal (detection of an animal serves as a trigger) is set.

In Step S5, the information processing apparatus 1 performs one-frame processing by the neural network NN1 and compresses data. One-frame image data is processed using the neural network NN1. Data (feature map) of the bottleneck portion BN12 of the neural network NN1 obtained by the processing is compressed.

In Step S6, the information processing apparatus 1 transmits the compressed data to the information processing apparatus 2. The compressed data is transmitted from the information processing apparatus 1 to the information processing apparatus 2 via the transmission path TL2. The process of Step S6 may be incorporated into the process of SetSceneData of the NICE protocol.

“SetSceneData” is an API for sending data acquired at the time when the trigger set in SetSceneMode is turned ON. Examples of SetSceneData include “RGB image/video clip data”, “IR image/video clip data”, “RGB IR image/video clip data”, “Depth Map”, “Stereo image data (RGB, RGBIR or IR)”, “Audio”, “Temperature”, “Humidity”, “Carbon Monoxide”, and “Passive Infrared”.

In Step S7, the information processing apparatus 2 decompresses the compressed data and performs one-frame processing by the neural network NN2. The compressed data transmitted from the information processing apparatus 1 is decompressed by the decompressor 24 to obtain data before compression. The processing section 22 processes the obtained data, that is, the data of the bottleneck portion BN12 of the neural network NN1 using the neural network NN2. The neural network NN2 outputs output data.

The processing of the one-frame image data using the overall neural network NN is completed by the processing of Steps S5 to S7 described above. In Steps S8 to S10, processing similar to that in Steps S5 to S7 is performed on the next one-frame image data. In other words, similar processing is iterated for each piece of one-frame image data.

Various processing based on the processing result may be performed. For example, the information processing apparatus 2 transmits (notification or the like) information to be fed back to the user or the like of the information processing apparatus 1 to the information processing apparatus 1 as necessary. Presentation of information using an image or sound is performed by the information processing apparatus 1 to perform to the user. For example, if the user of the information processing apparatus 1 is a driver of a vehicle, messages such as “It is rough driving, be careful” and “please make sure not to drive too fast on a narrow road” may be presented.

For example, as described above, the neural network NN1 and the neural network NN2 can be distributed and arranged in the information processing apparatus 1 and the information processing apparatus 2 to realize the information processing system 100. As described above, the information processing system 100 can perform high-performance processing by utilizing the plurality of devices of the information processing apparatus 1 and the information processing apparatus 2. In addition, since the data of the bottleneck portion BN12 of the neural network NN1 of the information processing apparatus 1 is transmitted to the information processing apparatus 2, the amount of transmission data can be suppressed.

### 1.4. Dynamic Change in Range of First Neural Network

The range of the neural network NN1 in the overall neural network NN may be dynamically changed according to the situation of the information processing apparatus 1. Examples of the situation of the information processing apparatus 1 include a heat generation situation of the information processing apparatus 1 and a battery remaining amount situation of the information processing apparatus 1.

The neural network NN1 after the change of the range also includes the bottleneck portion BN12 in the output portion. The bottleneck portion BN12 in the output portion of the neural network NN1 after the change is different from the bottleneck portion BN12 in the output portion of the neural network NN1 before the change. In other words, the change of the range of the neural network NN1 includes a change of the bottleneck portion BN12 in the output portion of the neural network NN1.

For example, when generation of heat increases or the amount of remaining battery decreases, and there is no longer enough processing capacity, the range of the neural network NN1 is narrowed so that the processing load in the information processing apparatus 1 is reduced. The bottleneck portion BN12 in the output portion of the neural network NN1 is changed to the bottleneck portion BN located at a further preceding stage. Since the neural network NN2 constitutes a portion (remainder) other than the neural network NN1 in the overall neural network NN, the range of the neural network NN2 is expanded. Part of the processing of the information processing apparatus 1 is borne by the information processing apparatus 2, thus reducing the processing load on the information processing apparatus 1.

A specific example will be described. In the initial situation, since generation of heat of the information processing apparatus 1 is small or the amount of remaining battery is sufficient, there is room for processing capacity. In this case, for example, the range of the neural network NN1 is determined so that up to the output portion of the Cell 7 depicted in FIG. 7 described above is included in the neural network NN1. When generation of heat of the information processing apparatus 1 increases or the amount of remaining battery decreases, the processing capacity of the information processing apparatus 1 becomes insufficient. Accordingly, the range of the neural network NN11 is narrowed so that up to the output portion of the Cell 3 is included in the neural network NN1. This reduces the processing load of the information processing apparatus 1, and for example, suppresses generation of heat and a decrease in the amount of remaining battery.

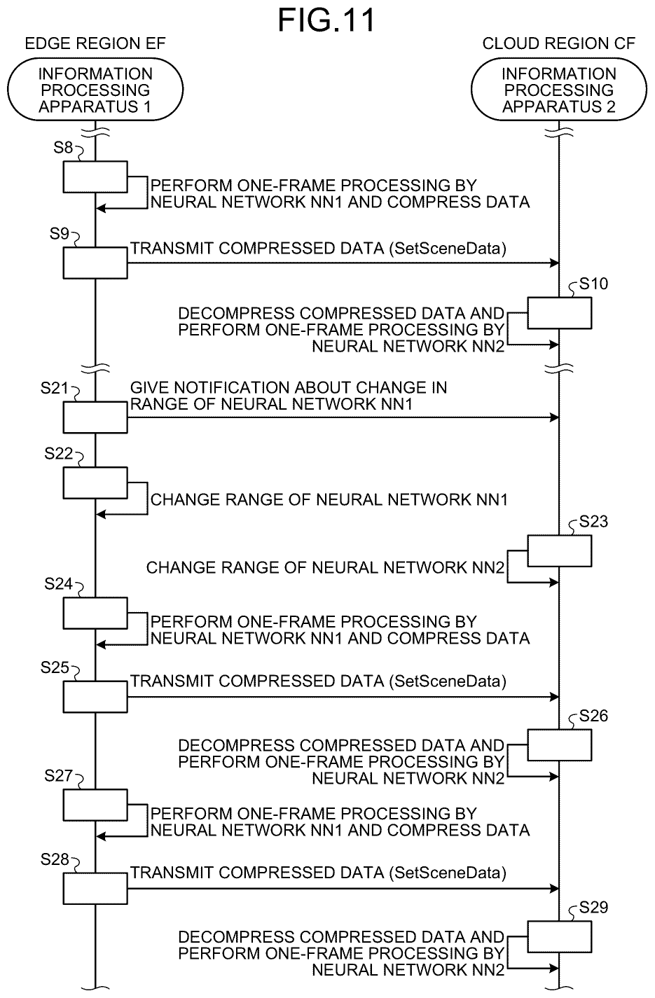

FIG. 11 is a flowchart depicting an example of processing (information processing method) executed in the information processing system. Steps S8 to S10 in FIG. 10 described above and subsequent processing are depicted. As a premise, in Step S4 (SetSceneMode) described above, the neural network NN1 in the assumed maximum range is transmitted from the information processing apparatus 2 to the information processing apparatus 1. An example of such a neural network NN1 is the neural network NN1 that includes up to the output portion of Cell 7 depicted in FIG. 7 described above. The presence of two or more bottleneck portions BN in the neural network NN1 and information (such as a position in the neural network NN1) on these bottleneck portions BN are also transmitted from the information processing apparatus 2 to the information processing apparatus 1.

While the processing of Steps S8 to S10 is iterated, the situation of the information processing apparatus 1 changes. The range of the neural network NN1 is changed according to the change in the situation of the information processing apparatus 1. Specifically, the processing of Steps S21 to S23 to be described below is executed.

In Step S21, the information processing apparatus 1 notifies the information processing apparatus 2 of a change in the range of the neural network NN1. The information processing apparatus 1 determines to change the range of the neural network NN1 according to the situation of the information processing apparatus 1. In this example, as described above, the processing capacity of the information processing apparatus 1 becomes insufficient, and the information processing apparatus 1 determines to narrow the range of the neural network NN1. For example, it is determined to change the range of the neural network NN1 from the range up to the output portion of the Cell 7 depicted in FIG. 7 described above to the range up to the output portion of the Cell 3. The information processing apparatus 1 transmits information, indicating the range of the neural network NN1 after the change, to the information processing apparatus 2.

In Step S22, the information processing apparatus 1 changes the range of the neural network NN1. The bottleneck portion BN12 in the output portion of the neural network NN1 is also changed. In this example, the range of the neural network NN1 is narrowed, and the bottleneck portion BN12 in the output portion is changed to the bottleneck portion BN located at a further preceding stage.

In Step S23, the information processing apparatus 2 changes the range of the neural network NN2. In this example, the range of the neural network NN2 is expanded. The neural network NN2 after the change constitutes the overall neural network NN together with the neural network NN1 after the change.

In Steps S24 to S26, the next one-frame image data is processed using the neural network NN1 after the change and the neural network NN12 after the change, that is, the overall neural network NN. The details are the same as those in the above Steps S5 to S7 (FIG. 10), and thus the description will not be repeated. In Steps S27 to S29, similar processing is performed on the next one-frame image data. In other words, similar processing is iterated for each piece of one-frame image data.

For example, the range of the neural network NN1 can be dynamically changed as described above. For example, it is possible to inhibit the processing of the entire information processing system 100 from being delayed or inhibit the information processing system 100 from being stopped due to insufficiency of the processing capacity of the information processing apparatus 1. It is also possible to extend the operating time of the information processing apparatus 1 and thus the operating time of the information processing system 100 by suppressing generation of heat of the information processing apparatus 1 and a decrease in the amount of remaining battery. Incidentally, as a matter of course, the range of the neural network NN1 may be expanded according to the situation of the information processing apparatus 1.

### 2. Hardware Configuration Example

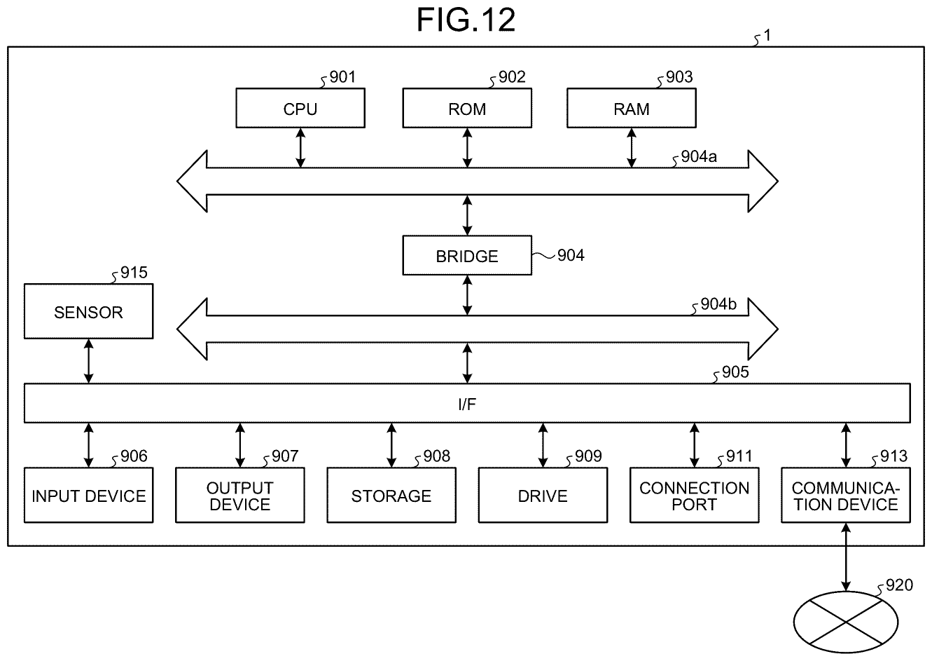

FIG. 12 is a block diagram depicting an example of a hardware configuration. Hereinafter, the information processing apparatus 1 will be described as an example. The same description goes for the information processing apparatus 2. Various processes are realized by cooperation of software and hardware to be described below.

As depicted in FIG. 12, the information processing apparatus 1 includes a Central Processing Unit (CPU) 901, a Read Only Memory (ROM) 902, a Random Access Memory (RAM) 903, and a host bus 904a. The information processing apparatus 1 further includes a bridge 904, an external bus 904b, an interface 905, an input device 906, an output device 907, a storage device 908, a drive 909, a connection port 911, a communication device 913, and a sensor 915. The information processing apparatus 2 may include a processing circuit such as a DSP or an ASIC instead of or in addition to the CPU 901.

The CPU 901 functions as an arithmetic processing device and a control device, and controls the overall operation in the information processing apparatus 1 according to various programs (such as the program P11 and the program P12). Further, the CPU 901 may be a microprocessor. The ROM 902 stores programs, arithmetic parameters, and the like used by the CPU 901. The RAM 903 temporarily stores programs used in the execution of the CPU 901, parameters that change as appropriate in the execution, and the like. The CPU 901 can embody, for example, the processing section 112, the processing section 122, and the like of the information processing apparatus 1.

The CPU 901, the ROM 902, and the RAM 903 are mutually connected by the host bus 904a including a CPU bus and the like. The host bus 904a is connected to the external bus 904b such as a Peripheral Component Interconnect/Interface (PCI) bus via the bridge 904. Incidentally, the host bus 904a, the bridge 904, and the external bus 904b do not necessarily have to have a configuration separated from each other, and may be implemented in a single configuration (for example, one bus).

The input device 906 is realized by, for example, a device to which information is input by a performer, such as a mouse, a keyboard, a touch panel, a button, a microphone, a switch, and a lever. Alternatively, the input device 906 may be, for example, a remote control device using infrared rays or other radio waves, or may be an external connection device such as a mobile phone or a PDA corresponding to the operation of the information processing apparatus 1. Further, the input device 906 may include, for example, an input control circuit or the like that generates an input signal on the basis of information input by the performer using the above input means and outputs the input signal to the CPU 901. By operating the input device 906, the performer can input various kinds of data to the information processing apparatus 1 or instruct the information processing apparatus 1 to perform a processing operation.

The output device 907 is formed of a device capable of visually or audibly notifying the performer of the acquired information. Examples of such a device include a display device such as a CRT display device, a liquid crystal display device, a plasma display device, an EL display device, and a lamp, a sound output device such as a speaker and a headphone, and a printer device.

The storage device 908 is a device for storing data. The storage device 908 is realized by, for example, a magnetic storage device such as an HDD, a semiconductor storage device, an optical storage device, a magneto-optical storage device, or the like. The storage device 908 may include a storage medium, a recording device that records data in the storage medium, a reading device that reads data from the storage medium, a deletion device that deletes data recorded in the storage medium, and the like. The storage device 908 stores programs executed by the CPU 901, various kinds of data, various kinds of data acquired from the outside, and the like. The storage device 908 can embody, for example, the storage section 113, the storage section 123, and the like of the information processing apparatus 1.

The drive 909 is a reader/writer for a storage medium, and is built in or externally attached to the information processing apparatus 1. The drive 909 reads information recorded in a removable storage medium such as a mounted magnetic disk, optical disk, magneto-optical disk, or semiconductor memory, and outputs the information to the RAM 903. The drive 909 can also write information to the removable storage medium.

The connection port 911 is an interface connected to an external device, and is a connection port to an external device capable of transmitting data by, for example, a Universal Serial Bus (USB) or the like.

The communication device 913 is, for example, a communication interface formed by a communication device or the like for connecting to a network 920 (corresponding to the network N in FIG. 1, for example). The communication device 913 is, for example, a communication card for wired or wireless Local Area Network (LAN), Long Term Evolution (LTE), Bluetooth (registered trademark), Wireless USB (WUSB), or the like. Alternatively, the communication device 913 may be a router for optical communication, a router for Asymmetric Digital Subscriber Line (ADSL), a modem for various kinds of communication, or the like. For example, the communication device 913 can transmit and receive signals and the like to and from the Internet and other communication devices according to a predetermined protocol such as TCP/IP. The communication device 913 can embody, for example, the transmission section 114, the receiving section 121, the transmission section 124, and the like of the information processing apparatus 1.

The sensor 915 functions as a sensor included in the information processing apparatus 1, for example, the acquisition section 111 (camera or the like).

Incidentally, the network 920 is a wired or wireless transmission path of information transmitted from a device connected to the network 920. For example, the network 920 may include a public network such as the Internet, a telephone network, or a satellite communication network, various Local Area Networks (LANs) including Ethernet (registered trademark), a Wide Area Network (WAN), or the like. Further, the network 920 may include a dedicated line network such as an Internet Protocol-Virtual Private Network (IP-VPN).

The hardware configuration example capable of realizing the functions of the information processing apparatus 1 has been described above. Each of the above-described components may be realized using a general-purpose member, or may be realized by hardware specialized for the function of each component. Accordingly, it is possible to change the hardware configuration to be used as appropriate according to the technical level at the time of implementing the present disclosure.

Incidentally, a computer program (such as the program P11 and the program P12) for realizing each function of the information processing apparatus 1 as described above can be created and mounted on a PC or the like. Further, a computer-readable recording medium storing such a computer program can also be provided. The recording medium includes, for example, a magnetic disk, an optical disk, a magneto-optical disk, a flash memory, and the like. Furthermore, the computer program described above may be distributed via, for example, a network without using a recording medium.

### 3. Effect Example

The technology described above is specified as follows, for example. One of the disclosed technologies is the information processing apparatus 1. As has been described with reference to FIGS. 1 to 4 and the like, the information processing apparatus 1 includes: the processing sections 112 and 122 that process data using the neural network NN1 (first neural network) which constitutes a part of the overall neural network NN and includes, in the output portion, the bottleneck portion BN12 where the amount of transmission data is minimum or extremely small in the overall neural network NN; and the transmission section 124 that transmits data of the bottleneck portion BN12 of the neural network NN1, obtained by the processing using the neural network NN1 performed by the processing sections 112 and 122, to the outside (for example, the information processing apparatus 2).

According to the information processing apparatus 1 described above, the data of the bottleneck portion BN12 of the neural network NN1 is transmitted to the outside. This makes it possible to suppress the amount of transmission data as compared with the case where data of the portions other than the bottleneck portion BN is transmitted as it is.

As described with reference to FIG. 4 and the like, the bottleneck portion BN12 may be a portion where the amount of transmission data in the overall neural network NN in a portion not bypassed by the shortcut connection SC is minimum or extremely small. All the data at that stage passes through such a bottleneck portion BN12, thus making it possible to transmit data necessary for processing in the overall neural network NN without omission.

As described with reference to FIG. 4 and the like, the bottleneck portion BN12 may be at least one of a portion where the number of channels is minimum or extremely small in the overall neural network NN and a portion where the cell size of the feature map is minimum or extremely small in the overall neural network NN. For example, such a portion can be set as the bottleneck portion BN12.

As has been described with reference to FIG. 5 and the like, the information processing apparatus 1 may include the compressor 126 that compresses the data of the bottleneck portion BN12, and the transmission section 124 may transmit the data compressed by the compressor 126. This makes it possible to further suppress the amount of transmission data.

As has been described with reference to FIGS. 3 and 6 and the like, the data of the bottleneck portion B12 includes the feature map, and the compression by the compressor 126 may include at least one of data compression by motion compensation, data compression by transformation into a frequency domain, data compression by quantization, and data compression by entropy coding. For example, by using such a data compression format, the data of the feature map can be efficiently compressed.

The information processing system 100 described with reference to FIGS. 1 and 2 and the like is also one of the disclosed technologies. The information processing system 100 includes: the information processing apparatus 1 (first information processing apparatus) described above; and the information processing apparatus 2 (second information processing apparatus) that processes data of the bottleneck portion BN12 of the neural network NN1 of the information processing apparatus 1 using the neural network NN2 (second neural network) constituting the remainder of the overall neural network NN. By utilizing a plurality of devices, that is, the information processing apparatus 1 and the information processing apparatus 2, for example, high-performance processing can be performed as compared with a case of using only the information processing apparatus 1.

As has been described with reference to FIGS. 1 to 3 and the like, the information processing apparatus 1 includes: the edge processing device 11 that processes data using the neural network N11 which constitutes a part of the neural network NN1 and includes, in the output portion, the bottleneck portion BN11 where the amount of transmission data is minimum or extremely small in the neural network NN1; and the intermediate processing device 12 that processes data of the bottleneck portion BN11 of the neural network NN11 of the edge processing device 11 using the neural network N12 which constitutes the remainder of the neural network N11 and includes, in the output portion, the bottleneck portion BN12 where the amount of transmission data is minimum or extremely small in the overall neural network NN. The information processing apparatus 2 processes data of the bottleneck portion BN12 of the neural network NN12 of the intermediate processing device 12, and data may be transmitted from the edge processing device 11 to the intermediate processing device 12 via the transmission path TL1 (private transmission path) and data may be transmitted from the intermediate processing device 12 to the information processing apparatus 2 via the transmission path TL2 (public transmission path). By utilizing the three devices of the edge processing device 11, the intermediate processing device 12, and the information processing apparatus 2, high-performance processing can be performed. Further, for example, in a case where the data to be transmitted is the feature map, the feature map of the subsequent stage in which the information of the original image data is lost is transmitted via the transmission path TL2 (public transmission path). This enables problems such as privacy caused by data transmission to hardly occur.

The information processing apparatus 2 described with reference to FIGS. 1 to 4 and the like is also one of the disclosed technologies. The information processing apparatus 2 includes: the receiving section 21 that receives, from the outside (for example, the information processing apparatus 1), data of the bottleneck portion BN12 of the neural network NN1 (first neural network) which constitutes a part of the overall neural network NN and includes, in the output portion, the bottleneck portion BN12 where the amount of transmission data is minimum or extremely small in the overall neural network NN; and the processing section 22 that processes the data of the bottleneck portion BN12 of the neural network NN1 received by the receiving section 21 using the neural network NN2 (second neural network) constituting the remainder of the overall neural network NN. Such an information processing apparatus 2 can also suppress the amount of transmission data as has been described above. In addition, high-performance processing can be performed by utilizing a plurality of devices of the information processing apparatus 1 and the information processing apparatus 2.

The computer-readable recording medium described with reference to FIGS. 2 and 12 and the like is also one of the disclosed technologies. The computer-readable recording medium is a computer-readable recording medium that records a program for causing a computer to function as: the processing sections 112 and 122 that process data using the neural network (first neural network) which constitutes a part of the overall neural network NN and includes, in the output portion, the bottleneck portion BN12 where the amount of transmission data is minimum or extremely small in the overall neural network NN; and the transmission section 124 that transmits data of the bottleneck portion BN12 of the neural network NN1, obtained by the processing performed by the processing sections 112 and 122, to the outside (for example, the information processing apparatus 2). Such a computer-readable recording medium can also suppress the amount of transmission data as has been described above.

The information processing method described with reference to FIG. 10 and the like is also one of the disclosed technologies. The information processing method includes: causing the information processing apparatus 2 (second information processing apparatus) to prepare, according to the capability of the information processing apparatus 1 (first information processing apparatus), the neural network NN1 (first neural network) that constitutes a part of the overall neural network NN and includes, in the output portion, the bottleneck portion BN12 where the amount of transmission data is minimum or extremely small in the overall neural network NN (Step S3); and causing the information processing apparatus 2 to transmit the prepared neural network NN1 to the information processing apparatus 1 (Step S4). For example, by obtaining (manufacturing) the information processing apparatus 1 in this manner, it is possible to suppress the amount of transmission data as has been described above.

As has been described with reference to FIG. 10 and the like, the information processing method may include: causing the information processing apparatus 1 to process data using the neural network NN1 and transmit the data of the bottleneck portion BN12 of the neural network NN obtained by the processing to the information processing apparatus 2 (Steps S6 and S9); and causing the information processing apparatus 2 to process the data of the bottleneck portion BN12 of the neural network NN1 of the information processing apparatus 1 using the neural network NN2 (second neural network) constituting the remainder of the overall neural network NN (Steps S7 and S10). This makes it possible to perform high-performance processing utilizing a plurality of devices of the information processing apparatus 1 and the information processing apparatus 2.

As has been described with reference to FIG. 12 and the like, the information processing method may include: causing the information processing apparatus 1 to change the range of the neural network NN1 in the overall neural network NN according to the situation of the information processing apparatus 1 (such as a situation of generation of heat and a situation of the amount of remaining battery) (Step S22); and causing the information processing apparatus 2 to change the range of the neural network NN2 in the overall neural network NN according to the situation of the information processing apparatus 1 (Step S23). As a result, the range of the neural network NN1 in the overall neural network NN can be dynamically changed according to the situation of the information processing apparatus 1. For example, it is possible to inhibit the processing of the entire information processing system 100 from being delayed or inhibit the information processing system 100 from being stopped due to insufficiency of the processing capacity of the information processing apparatus 1.

### 4. Application Example

The technology according to the present disclosure can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, a robot, a construction machine, or an agricultural machine (tractor).

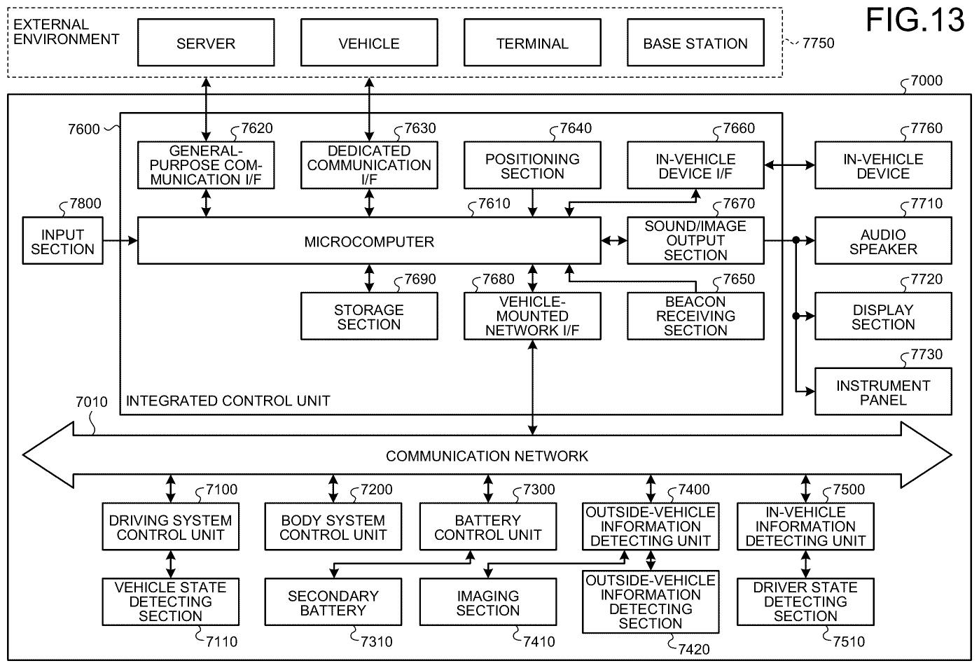

FIG. 13 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 13, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 13 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

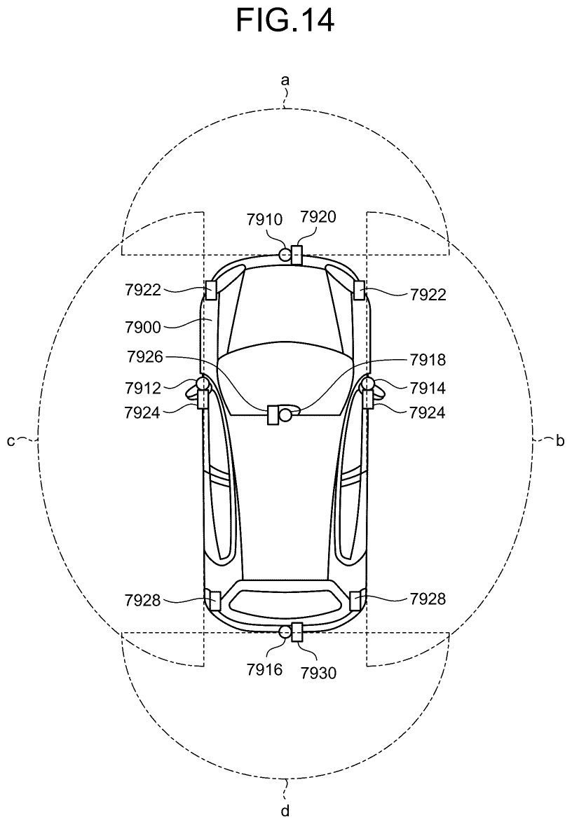

FIG. 14 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 14 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 13, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 13, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 13 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for realizing the functions of the information processing apparatus 1 according to the present embodiment described with reference to FIGS. 1 and 2 and the like can be mounted on any control unit or the like. Further, a computer-readable recording medium storing such a computer program can also be provided. The recording medium includes, for example, a magnetic disk, an optical disk, a magneto-optical disk, a flash memory, and the like. Furthermore, the computer program described above may be distributed via, for example, a network without using a recording medium.

In the vehicle control system 7000 described above, the information processing apparatus 1 according to the present embodiment described with reference to FIGS. 1 and 2 and the like can be applied to the integrated control unit 7600 of the application example illustrated in FIG. 13. For example, the processing sections 112 and 122, the storage sections 113 and 123, the transmission section 114, the receiving section 121, and the transmission section 124 of the information processing apparatus 1 can correspond to the microcomputer 7610, the storage section 7690, and the vehicle-mounted network I/F 7680 of the integrated control unit 7600. For example, the integrated control unit 7600 functions as the processing section 112 and the processing section 112, so that data can be processed using the neural network NN1.

Further, at least some components of the information processing apparatus 1 described with reference to FIGS. 1 and 2 and the like may be realized in a module (for example, an integrated circuit module including one die) for the integrated control unit 7600 illustrated in FIG. 13. Alternatively, the information processing apparatus 1 described with reference to FIGS. 1 and 2 and the like may be realized by a plurality of control units of the vehicle control system 7000 illustrated in FIG. 13.

Incidentally, the effects described in the present disclosure are merely examples and are not limited to the disclosed contents. There may be other effects.

Although the embodiments of this disclosure have been described above, the technical scope of this disclosure is not limited to the above-described embodiments as it is, and various modifications can be made without departing from the gist of this disclosure. In addition, components of different embodiments and modifications may be appropriately combined.

Incidentally, the present technology can also have the following configuration.

(1) An information processing apparatus comprising:
a processing section that processes data using a first neural network which constitutes a part of an overall neural network and includes, in an output portion, a bottleneck portion where the amount of transmission data is minimum or extremely small in the overall neural network; and
a transmission section that transmits data of the bottleneck portion of the first neural network, obtained by the processing using the first neural network performed by the processing section, to the outside.

(2) The information processing apparatus according to (1), wherein
the bottleneck portion is a portion where the amount of transmission data in the overall neural network in a portion not bypassed by a shortcut connection is minimum or extremely small.

(3) The information processing apparatus according to (1) or (2), wherein
the bottleneck portion is at least one of
a portion where the number of channels is minimum or extremely small in the overall neural network, and
a portion where a cell size of a feature map is minimum or extremely small in the overall neural network.

(4) The information processing apparatus according to any one of (1) to (3), comprising
a compressor that compresses the data of the bottleneck portion, wherein
the transmission section transmits data compressed by the compressor.

(5) The information processing apparatus according to (4), wherein
the data of the bottleneck portion includes a feature map, and
the compression by the compressor includes at least one of
data compression by motion compensation,
data compression by transformation into a frequency domain,
data compression by quantization, and
data compression by entropy coding.

(6) An information processing system comprising:
a first information processing apparatus that is the information processing apparatus according to any one of (1) to (5); and
a second information processing apparatus that processes data of the bottleneck portion of the first neural network of the first information processing apparatus using a second neural network constituting the remainder of the overall neural network.

(7) The information processing system according to (6), wherein
the first information processing apparatus includes:
an edge processing device that processes data using a neural network which constitutes a part of the first neural network and includes, in an output portion, a bottleneck portion where the amount of transmission data is minimum or extremely small in the first neural network; and
an intermediate processing device that processes data of the bottleneck portion of the neural network of the edge processing device using a neural network which constitutes the remainder of the first neural network and includes, in an output portion, the bottleneck portion where the amount of transmission data is minimum or extremely small in the overall neural network,
the second information processing apparatus processes data of the bottleneck portion of the neural network of the intermediate processing device,
data is transmitted from the edge processing device to the intermediate processing device via a private transmission path, and
data is transmitted from the intermediate processing device to the second information processing apparatus via a public transmission path.

(8) An information processing apparatus comprising:
a receiving section that receives, from the outside, data of a bottleneck portion of a first neural network which constitutes a part of an overall neural network and includes the bottleneck portion in an output portion, the bottleneck portion being a portion where the amount of transmission data is minimum or extremely small in the overall neural network; and
a processing section that processes the data of the bottleneck portion of the first neural network received by the receiving section using a second neural network constituting the remainder of the overall neural network.

(9) A computer-readable recording medium that records a program for causing a computer to function as:
a processing section that processes data using a first neural network which constitutes a part of an overall neural network and includes, in an output portion, a bottleneck portion where the amount of transmission data is minimum or extremely small in the overall neural network; and
a transmission section that transmits data of the bottleneck portion of the first neural network, obtained by the processing performed by the processing section, to the outside.

(10) An information processing method comprising:
by a second information processing apparatus, preparing, according to a capability of a first information processing apparatus, a first neural network that constitutes a part of an overall neural network and includes, in an output portion, a bottleneck portion where the amount of transmission data is minimum or extremely small in the overall neural network; and
by the second information processing apparatus, transmitting the prepared first neural network to the first information processing apparatus.

(11) The information processing method according to (10), comprising:
by the first information processing apparatus, processing data using the first neural network and transmitting data of the bottleneck portion of the first neural network obtained by the processing to the second information processing apparatus; and
by the second information processing apparatus, processing the data of the bottleneck portion of the first neural network of the first information processing apparatus using a second neural network constituting the remainder of the overall neural network.

(12) The information processing method according to (11), comprising:
by the first information processing apparatus, changing a range of the first neural network in the overall neural network according to a situation of the first information processing apparatus; and
by the second information processing apparatus, changing a range of the second neural network in the overall neural network according to the situation of the first information processing apparatus.

(13) The information processing method according to (12), wherein
the situation of the first information processing apparatus includes at least one of a situation of generation of heat and a situation of the amount of remaining battery.

### REFERENCE SIGNS LIST

100 INFORMATION PROCESSING SYSTEM
1 INFORMATION PROCESSING APPARATUS
11 EDGE PROCESSING DEVICE
111 ACQUISITION SECTION
112 PROCESSING SECTION
113 STORAGE SECTION
114 TRANSMISSION SECTION
115 COMPRESSOR
12 INTERMEDIATE PROCESSING DEVICE
121 RECEIVING SECTION
122 PROCESSING SECTION
123 STORAGE SECTION
124 TRANSMISSION SECTION
125 DECOMPRESSOR
126 COMPRESSOR
2 INFORMATION PROCESSING APPARATUS
21 RECEIVING SECTION
22 PROCESSING SECTION
23 STORAGE SECTION
24 DECOMPRESSOR
BN BOTTLENECK PORTION
BN11 BOTTLENECK PORTION
BN12 BOTTLENECK PORTION
CF CLOUD REGION
EF EDGE REGION
IL INPUT LAYER
ML INTERMEDIATE LAYER
NN OVERALL NEURAL NETWORK
NN1 NEURAL NETWORK
NN11 NEURAL NETWORK
NN12 NEURAL NETWORK
NN2 NEURAL NETWORK
OL OUTPUT LAYER
P11 PROGRAM
P12 PROGRAM
P2 PROGRAM
SC SHORTCUT CONNECTION
TL1 TRANSMISSION PATH
TL2 TRANSMISSION PATH

1. An information processing apparatus comprising:
a processing section that processes data using a first neural network which constitutes a part of an overall neural network and includes, in an output portion, a bottleneck portion where the amount of transmission data is minimum or extremely small in the overall neural network; and
a transmission section that transmits data of the bottleneck portion of the first neural network, obtained by the processing using the first neural network performed by the processing section, to the outside.

2. The information processing apparatus according to claim 1, wherein
the bottleneck portion is a portion where the amount of transmission data in the overall neural network in a portion not bypassed by a shortcut connection is minimum or extremely small.

3. The information processing apparatus according to claim 1, wherein
the bottleneck portion is at least one of
a portion where the number of channels is minimum or extremely small in the overall neural network, and
a portion where a cell size of a feature map is minimum or extremely small in the overall neural network.

4. The information processing apparatus according to claim 1, comprising
a compressor that compresses the data of the bottleneck portion, wherein
the transmission section transmits data compressed by the compressor.

5. The information processing apparatus according to claim 4, wherein
the data of the bottleneck portion includes a feature map, and
the compression by the compressor includes at least one of
data compression by motion compensation,
data compression by transformation into a frequency domain,
data compression by quantization, and
data compression by entropy coding.

6. An information processing system comprising:
a first information processing apparatus that is the information processing apparatus according to claim 1; and
a second information processing apparatus that processes data of the bottleneck portion of the first neural network of the first information processing apparatus using a second neural network constituting the remainder of the overall neural network.

7. The information processing system according to claim 6, wherein
the first information processing apparatus includes:
an edge processing device that processes data using a neural network which constitutes a part of the first neural network and includes, in an output portion, a bottleneck portion where the amount of transmission data is minimum or extremely small in the first neural network; and
an intermediate processing device that processes data of the bottleneck portion of the neural network of the edge processing device using a neural network which constitutes the remainder of the first neural network and includes, in an output portion, the bottleneck portion where the amount of transmission data is minimum or extremely small in the overall neural network,
the second information processing apparatus processes data of the bottleneck portion of the neural network of the intermediate processing device,
data is transmitted from the edge processing device to the intermediate processing device via a private transmission path, and
data is transmitted from the intermediate processing device to the second information processing apparatus via a public transmission path.

8. An information processing apparatus comprising:
a receiving section that receives, from the outside, data of a bottleneck portion of a first neural network which constitutes a part of an overall neural network and includes the bottleneck portion in an output portion, the bottleneck portion being a portion where the amount of transmission data is minimum or extremely small in the overall neural network; and
a processing section that processes the data of the bottleneck portion of the first neural network received by the receiving section using a second neural network constituting the remainder of the overall neural network.

9. A computer-readable recording medium that records a program for causing a computer to function as:
a processing section that processes data using a first neural network which constitutes a part of an overall neural network and includes, in an output portion, a bottleneck portion where the amount of transmission data is minimum or extremely small in the overall neural network; and
a transmission section that transmits data of the bottleneck portion of the first neural network, obtained by the processing performed by the processing section, to the outside.

10. An information processing method comprising:
by a second information processing apparatus, preparing, according to a capability of a first information processing apparatus, a first neural network that constitutes a part of an overall neural network and includes, in an output portion, a bottleneck portion where the amount of transmission data is minimum or extremely small in the overall neural network; and
by the second information processing apparatus, transmitting the prepared first neural network to the first information processing apparatus.

11. The information processing method according to claim 10, comprising:
by the first information processing apparatus, processing data using the first neural network and transmitting data of the bottleneck portion of the first neural network obtained by the processing to the second information processing apparatus; and
by the second information processing apparatus, processing the data of the bottleneck portion of the first neural network of the first information processing apparatus using a second neural network constituting the remainder of the overall neural network.

12. The information processing method according to claim 11, comprising:
by the first information processing apparatus, changing a range of the first neural network in the overall neural network according to a situation of the first information processing apparatus; and
by the second information processing apparatus, changing a range of the second neural network in the overall neural network according to the situation of the first information processing apparatus.

13. The information processing method according to claim 12, wherein
the situation of the first information processing apparatus includes at least one of a situation of generation of heat and a situation of the amount of remaining battery.
